(19) United States
(12) Patent Application Publication
(10) Pub. No.: US 2002/0103067 A1
(43) Pub. Date: Aug. 1, 2002

(54) Bags with gussets, method and machine for manufacturing them

(75) Inventor: Henri Georges Bois, Neuilly Sur Seine (FR)

Correspondence Address: Finnegan, Henderson, Farabow,, Garrett & Dunner, L.L.P., 1300 I Street, N.W., Washington, DC, 20005-3315, US

(73) Assignee: FLEXICO-FRANCE

(21) Appl. No.: 10/052,637

(22) Filed: Jan. 23, 2002

(30) Foreign Application Priority Data
Jan. 26, 2001 (FR) 01/01076

(51) Int. Cl. B65D 30/20; B31B 1/82

(52) U.S. Cl. 493/394; 383/61.2; 383/120

(57) ABSTRACT

The invention relates to a method of manufacturing packaging bags with side gussets comprising steps which consist in forming cutouts in the sheet of the bag, placing closure means (70) between two associated cutouts, forming side gussets, bringing the edges (14, 16) of the sheet together, wherein the cutouts open onto a transverse generatrix (18) of the sheet which corresponds to the top of a respective bag.

The invention also relates to a machine and to the bags thus obtained.

The present invention relates to the field of packaging bags.

More specifically, the present invention relates to the field of packaging bags with side gussets.

Numerous methods for producing bags with side gussets have already been proposed.

By way of non-limiting examples, reference may be made to documents FR-A-2 758 761, FR-A-2 686 063, U.S. Pat. No. 5,938,339, U.S. Pat. No. 6,068,585, DE-A-3824753 and JP-A-07214702.

The present invention now has the objective of proposing novel means of manufacturing bags with side gussets.

This objective is achieved in the context of the present invention by virtue of a method comprising the steps which consist in

driving a sheet that is intended to form a packaging bag in a longitudinal direction which coincides with its direction of elongation,

sequentially forming pairs of cutouts in two respective regions of the sheet of packaging bag which regions are intended to form longitudinal side gussets,

sequentially and transversely placing closure means based on complementary profiles on the sheet facing the region thereof that lies between two associated cutouts,

forming longitudinal side gussets on the sheet,

bringing the longitudinal edges of the sheet together, fixing together these touching longitudinal edges of the sheet to close the bag, and fixing the closure means based on complementary profiles, onto the sheet,

wherein the cutouts open onto a transverse generatrix of the sheet which corresponds to the top of a respective bag.

According to another advantageous feature of the present invention, the closure means based on complementary profiles are borne by a strip folded onto itself in the shape of a U to form two support flanges which are roughly parallel to one another, oriented transversely to the longitudinal direction of the bag and fixed respectively to the inside of two main panels of the bag which are formed by said sheet.

According to another advantageous feature of the present invention, the closure means based on complementary profiles comprise an operating slider.

The present invention also relates to a machine for implementing the aforementioned method and which comprises:

means capable of driving a sheet that is intended to form a packaging bag in a longitudinal direction which coincides with its direction of elongation,

means capable of sequentially forming pairs of cutouts in two respective regions of the sheet of packaging bag which regions are intended to form longitudinal side gussets,

means capable of sequentially and transversely placing closure means based on complementary profiles on the sheet facing the region thereof that lies between two associated cutouts,

means capable of forming longitudinal side gussets on the sheet,

means capable of bringing the longitudinal edges of the sheet together, fixing together these touching longitudinal edges of the sheet to close the bag, and fixing the closure means based on complementary profiles, onto the sheet,

wherein the means capable of forming pairs of cutouts are designed to make cutouts which open onto a transverse generatrix of the sheet corresponding to the top of a respective bag.

The present invention also relates to the bags thus obtained.

Other features, objects and advantages of the present invention will become apparent from reading the detailed description which will follow and from studying the appended drawings which are given by way of non-limiting examples and in which:

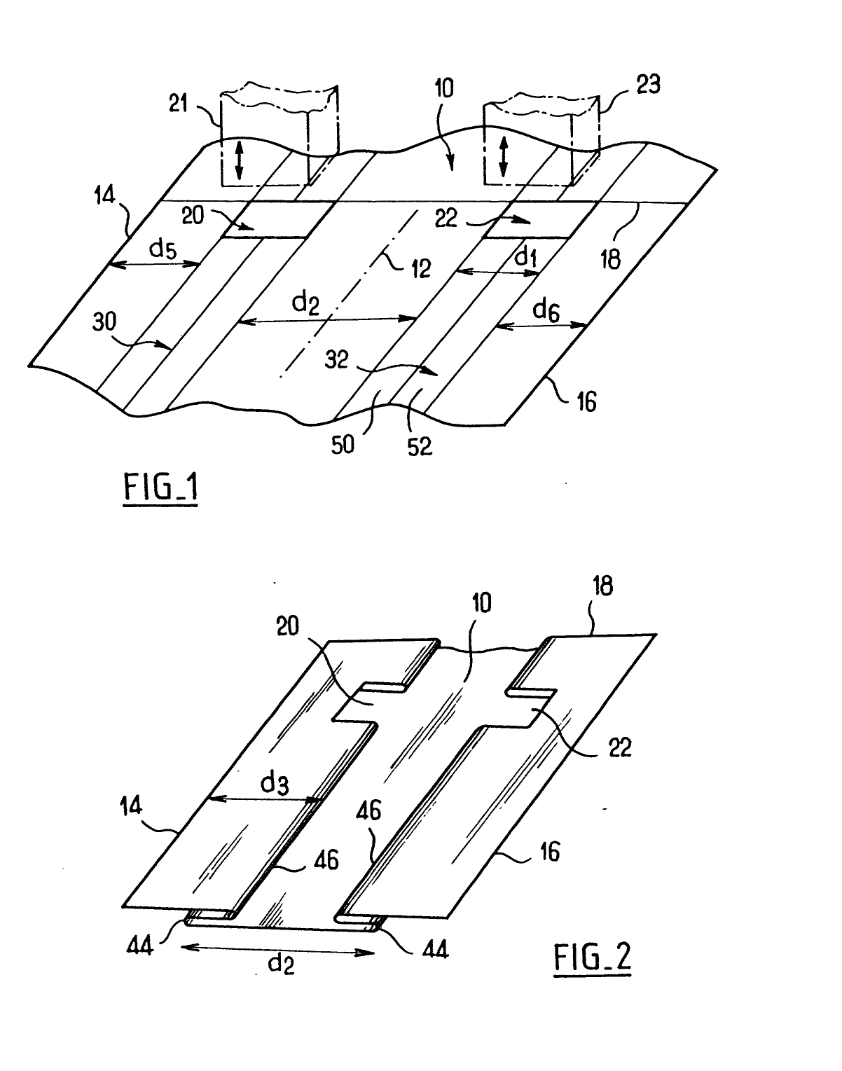

FIGS. 1 to 4 schematically depict four successive main steps in the method according to the present invention,

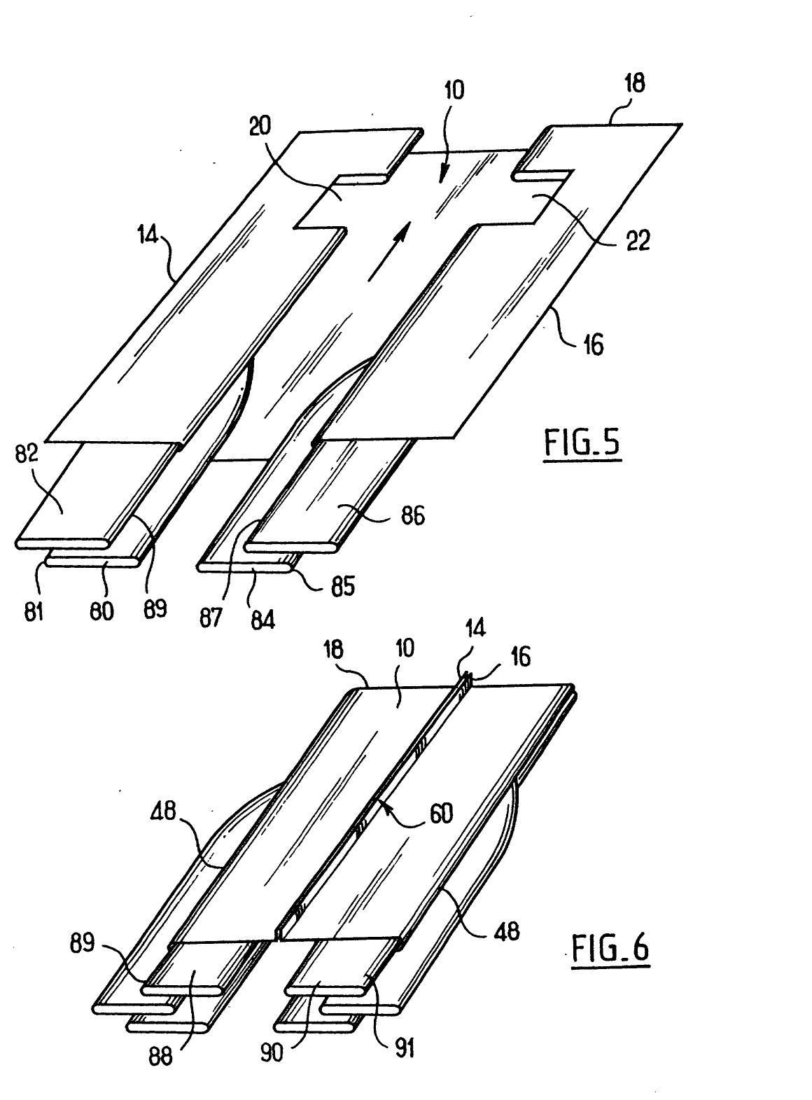

FIGS. 5 and 6 schematically illustrate the means intended to produce the side gussets,

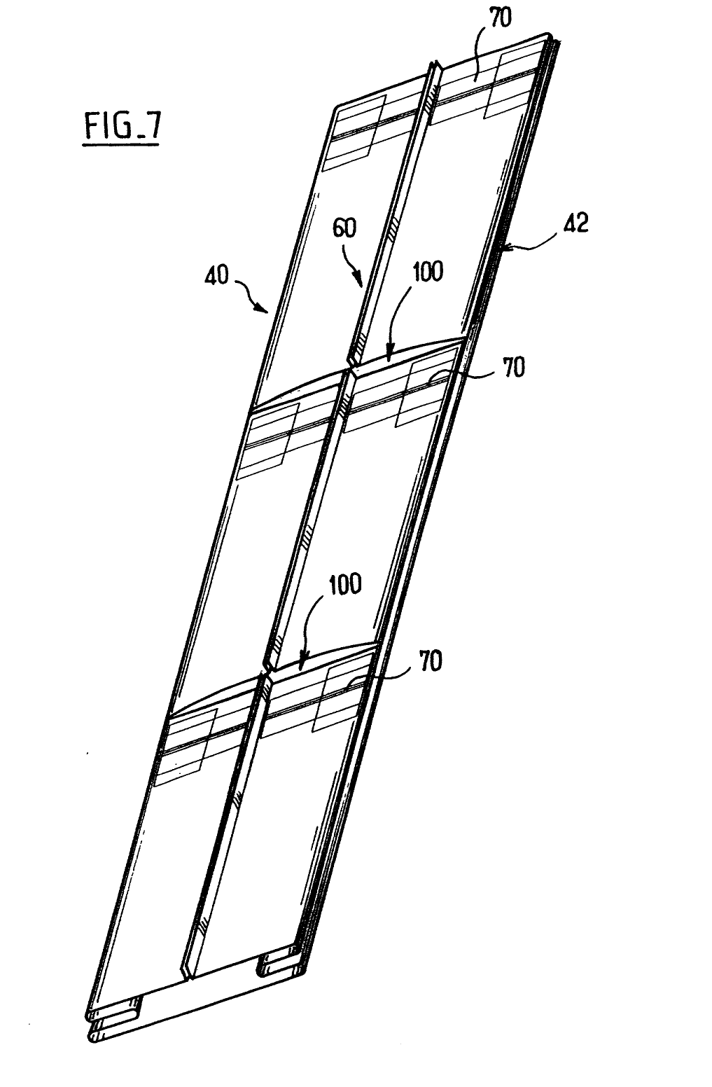

FIG. 7 schematically illustrates a set of bags in a string according to the present invention, and

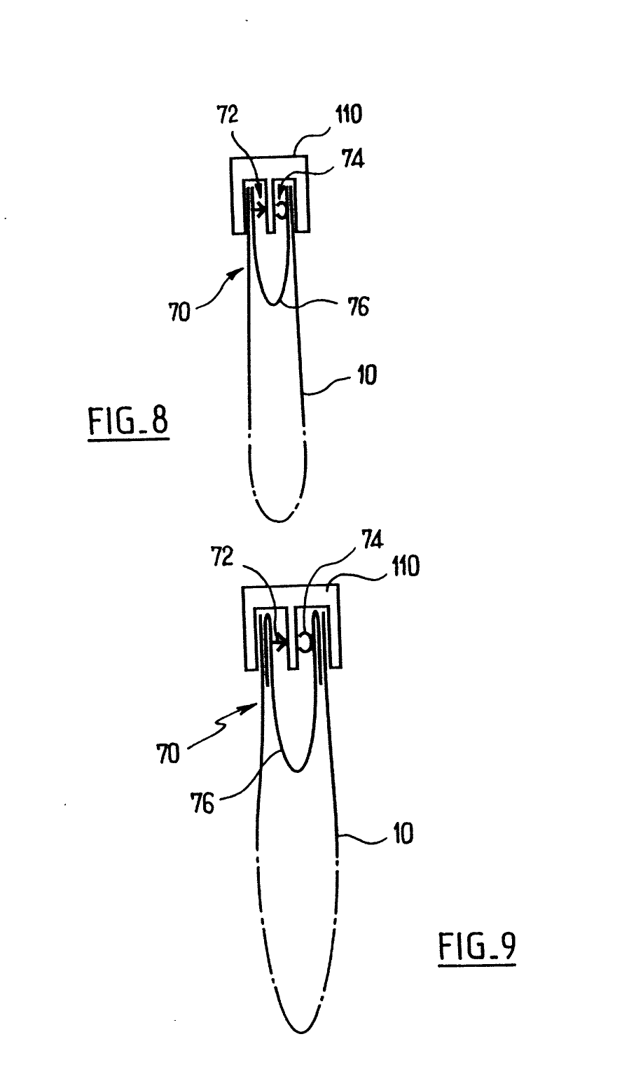

FIGS. 8 and 9 schematically depict, in views in cross section, two alternative forms of bag according to the present invention and comprising closure means equipped with a slider.

The appended FIG. 1 shows a sheet 10, the direction of elongation of which is referenced 12 and the longitudinal edges parallel to it are referenced 14 and 16.

The sheet 10 is made to move, by any appropriate means, typically from a roll holding a reserve, in its direction of elongation 12.

As depicted in FIG. 1, pairs of cutouts 20, 22 are produced sequentially in the sheet 10, in two regions 30, 32 of the sheet 10 which regions are intended later to form the longitudinal side gussets 40, 42.

Such cutouts 20, 22 may be made using conventional punches drawn in schematically with the reference 21, 23 in FIG. 1. The progress of the film 10 in direction 12 may be interrupted while the punches 20, 23 are moving.

In FIG. 1, a generatrix that is transverse to the direction of elongation 12 that coincides with the top of a bag has been referenced 18.

As can be seen in FIG. 1, the cutouts 20, 22 open onto this generatrix 18.

The longitudinal spacing (i.e. the spacing in the direction 12) between adjacent pairs of cutouts 20, 22 is equal to the spacing of the bags.

A geometry of the cutouts 20, 22 may be the subject of various alternative forms. Advantageously, the cutouts 20, 22 are rectangular, their sides being respectively parallel to the longitudinal direction of elongation 12 and to the transverse direction 18.

As a preference, the transverse dimension dl of the cutouts 20, 22 is equal to the combined width of the flaps 50, 52 defining the concave internal dihedron of the side gussets 40, 42.

For a final longitudinal weld 60 for closing the bag, lying midway across the width thereof (as illustrated in FIG. 4), the two cutouts 20, 22 are symmetric with respect to the middle of the sheet. On the other hand, if the longitudinal closure weld 60 is to be offset from the middle of the bag, the cutouts 20, 22 will be offset accordingly, the distance d2 separating the two cutouts being equal to the width of the main panel of which the bag is made.

The sum d5+d6 of the width of the panels formed on the outside of the cutouts 20, 22 is equal to the width d2 of the panel formed between the cutouts 20, 22 plus twice the width d4 required to fix the longitudinal edges 14, 16 together.

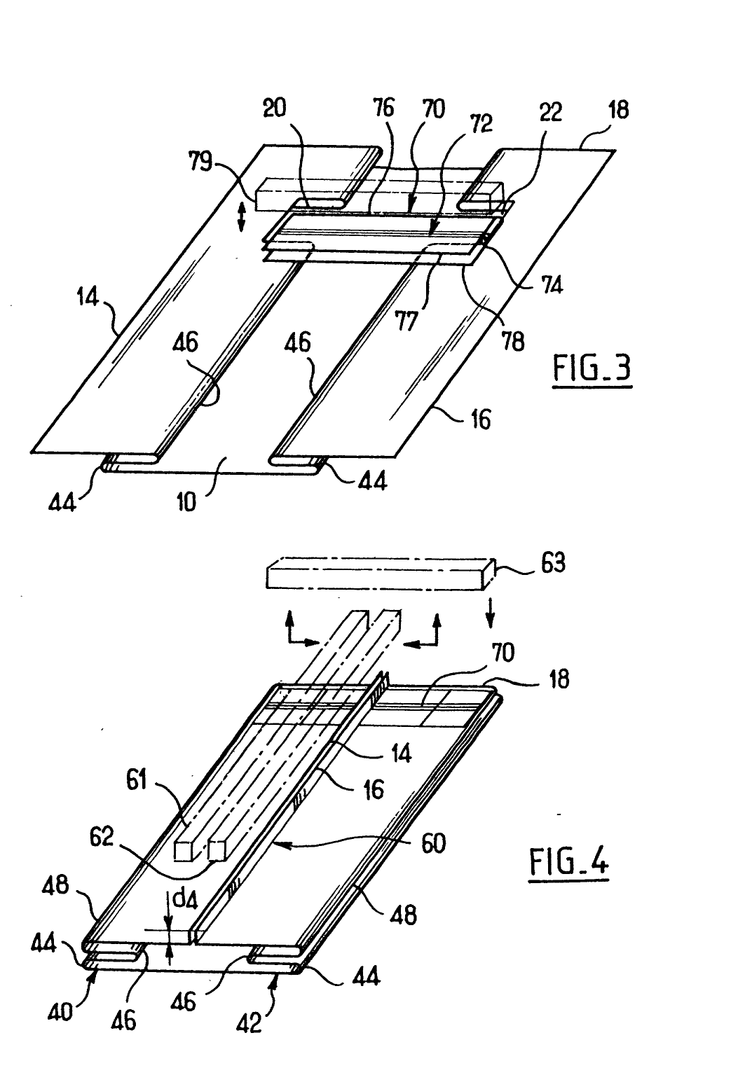

As can be seen in FIGS. 2 and 3, two side gussets 40, 42 are then formed in the sheet 10 and closure means 70 are placed sequentially and transversely on the sheet 10 facing the region lying between two cutouts 20, 22.

The means which convey and position the closure means 70 onto the film may be formed of any means known to those skilled in the art, for example those described in the aforementioned anterior documents.

According to the illustration given in the figures, the side gussets 20, 22 are roughed out before the closure means 70 are placed on the sheet 10.

However, the opposite solution may be adopted, that is to say that as an alternative, the closure means may be placed on the sheet 10 before the side gussets 40, 42 are roughed out or produced.

In the context of the present invention, the closure means 70 are preferably formed of complementary profiles 72, 74 borne by respective support flanges 77, 78, for example in the form of a strip 76 folded onto itself in the shape of a U. Thus, the strip 76 forms two support flanges 77, 78 which are roughly parallel to one another and oriented transversely to the longitudinal direction 12 of the bag.

The complementary profiles 72, 74 may be the subject of various alternative forms. They may for example be structures in the form of complementary hooks or alternatively may respectively be a male element in the shape of an arrow head and a female element in the shape of a groove with converging edges.

The U-shaped closure strip 76 may have its concave side facing toward the inside or toward the outside of the bag.

Furthermore, the closure strip 76 may have its concave side facing upstream or downstream with respect to the direction of travel of the sheet 10.

Once positioned on the sheet 10, the lower support flange 78 of the closure means is fixed, preferably by welding (if necessary by bonding or any other appropriate means) to the underlying lower panel of the sheet 10.

If necessary, to make it easier to fix the closure means 70 by welding, the two flanges 77, 78 may have different widths (in which case, the lower flange 78 is the wider one).

The reference 79 in FIG. 3 has been used to schematically depict a transverse welding machine intended to fix the lower flange 78 to the film 10.

The side gussets 40, 42 are formed using any appropriate means, for example using parallel blades 80, 82, 84, 86 running in the longitudinal direction 12 and the longitudinal blade edges 81, 83, 85 and 87 of which, alternately external or internal, are offset by an amount equal to the desired depth of the gussets, as illustrated in FIG. 5.

More specifically still, according to the depiction illustrated in the appended figures, the side gussets are produced in two stages: in a first stage (FIG. 2), two parallel longitudinal folds 44, 46 are produced at each gusset 40, 42, then shaped into a Z, and then in a second stage (FIG. 4), a last longitudinal fold 48 is produced at each gusset 40, 42 to finish these gussets.

The third fold 48 may be produced for example using a third blade 88, 90, as illustrated in FIG. 6, the external longitudinal blade edge 89, 91 of which is superposed with the external blade edge 81, 85 of the lower blade 80, 84.

Typically, the width d3 of each elementary panel formed between a longitudinal edge 14, 16 and an internal fold 46 is equal to the sum of half the width d2 of the lower panel formed between the two external folds 44, the depth d1/2 of the gussets (distance between the folds 44 and 46) and the width d4 needed to fix the longitudinal edges 14, 16 together (this being for a central longitudinal weld). If the longitudinal weld is not central, the sum of the width of the two elementary panels formed respectively between the longitudinal edges 14, 16 and an internal fold 46 is equal to the sum of the width d2 of the lower panel formed between the two external folds 44, twice (d1) the depth of the gussets and twice the width d4 needed to fix the longitudinal edges 14, 16 together.

It then remains for the two longitudinal edges 14, 16 of the sheet 10 to be brought together and fixed together using any appropriate means, preferably by welding, or even by bonding or some other equivalent means and for the second support flange 77 of the closure means to be fixed to the upper panel of the sheet of which the bag is made.

The longitudinal edges 14, 16 can be brought together by any appropriate means, for example using known rollers or chutes.

In FIG. 4, two welding jaws capable of making the longitudinal weld 60 have been depicted schematically as 61 and 62, and a transverse jaw capable of fixing the second flange 77 of the closure means 70 has been depicted schematically as 63.

The ways in which the bags are transversely closed and are filled may be the subject of various alternative forms of embodiment.

By way of non-limiting examples:

the tubular entity obtained after implementing the aforementioned steps may be packed as it is, for example rolled up on itself, or concertina-folded about transverse folds, so as to be used later, by cutting to form individual bags, filling these then closing them, for example using a transverse weld at the bottom of the bags;

as an alternative, each bag-forming element can be made into an individual bag by cutting transversely with a view to subsequent filling and closure;

each element of the aforementioned tubular entity corresponding to a bag may receive its contents before the last fold 48 is made. In this case, each bag may be hermetically sealed by making a transverse join, for example by welding, and turned into an individual bag by transverse cutting between this join corresponding to the bottom of a bag and the closure means corresponding to the top of the next bag;

as an alternative, the aforementioned tubular entity may be provided sequentially with transverse cutouts 100 made in one of its wall elements, as depicted schematically in FIG. 7, to form a string of bags in series. These cutouts 100 will be produced along the generatrix 18, between the top of one bag and the bottom of the next bag. Such cutouts 100 may be formed in the film 10 at the same time as the cutouts 20, 22. The presence of such cutouts makes subsequent cascade-type filling of the bags easier. Once the bags have been filled, they can be plugged by sealing the cutouts 100 using welding.

Of course, the present invention is not restricted to the particular embodiments which have just been described, but extends to any alternative forms that are in accordance with its spirit.

As mentioned previously and as illustrated in FIG. 8, the closure means 70 may be equipped with an operating slider 110. Such an operating slider, known per se, will not be described in detail. It will simply be recalled that such a slider 110 generally comprises a base 112 connected to two lateral flanks 113, 114 arranged one on each side of a central sole 116 designed to be placed between the complementary closure profiles. The lateral flanks 113, 114, in combination with the central sole, define two passages which converge toward one end of the slider. Moving the slider in one direction (convergent end of the passage downstream) brings the closure profiles closer together and closes the bag. Moving the slider 110 in the opposite direction separates the closure profiles 72, 74 by virtue of the sole 116 and opens the bag.

FIG. 8 thus depicts a U-shaped strip 76 with the concave side facing toward the outside and equipped with a slider 110.

FIG. 9 illustrates another alternative form of embodiment whereby the strip 76 is W-shaped, the closure profiles 72, 74 being placed between the inside of the internal U-shaped element of this strip 76, this internal U-shaped element having its concave side facing outward.

It will be noted that in the context of the present invention, the U-shaped support strip 76 forms an indication that the bag has been opened for the first time.

Specifically, it is necessary to tear this strip 76 to access the contents of the bag.

Thus, breakage of the strip 76 is an indicator that the bag has been opened.

If necessary, the strip 76 may have a line of weakness, for example in the form of a line of precuts, to make the bag easier to open.

In the context of the method according to the present invention, the sheet 10 can be moved one way or the other in the longitudinal direction 12.

The aforementioned means of cutting the film 10 and of sealing or closing in the transverse direction may be incorporated into the transverse jaw depicted schematically with the reference 63 in FIG. 4.

Furthermore, the closure assembly 70 is preferably fixed to the film 10 in such a way that it seals the closure means 70 and the film 10 and therefore also guarantees that the bag finally obtained will be sealed. To this end, the length of the closure strip 70 is preferably tailored so that the closure means 70 adjoins or, if necessary, partially overlaps, the outline of the cutouts 20, 22. Moreover, the means of fixing the closure strip 70 preferably welds the ends of these to the film 10.

The film 10 used in the context of the present invention may be embodied in any way known to those skilled in the art.

It is preferably a film based on a single- or multi-layer single- or multi-material thermoplastic. If necessary, it may be a paper support coated with a layer of thermoplastic, or alternatively a layer of partially metallized thermoplastic.

1. A method of manufacturing packaging bags with side gussets comprising the steps which consist in:
driving a sheet that is intended to form a packaging bag in a longitudinal direction which coincides with its direction of elongation,
sequentially forming pairs of cutouts in two respective regions of the sheet of packaging bag which regions are intended to form longitudinal side gussets,
sequentially and transversely placing closure means based on complementary profiles on the sheet facing the region thereof that lies between two associated cutouts,
forming longitudinal side gussets on the sheet,
bringing the longitudinal edges of the sheet together, fixing together these touching longitudinal edges of the sheet to close the bag, and fixing the closure means based on complementary profiles, onto the sheet,
wherein the cutouts open onto a transverse generatrix of the sheet which corresponds to the top of a respective bag.

2. The method as claimed in claim 1, wherein the closure means based on complementary profiles comprise an operating slider.

3. The method as claimed in claim 1 or 2, wherein the closure means based on complementary profiles are borne by a strip folded onto itself in the shape of a U to form two support flanges which are roughly parallel to one another, oriented transversely to the longitudinal direction of the bag and fixed respectively to the inside of two main panels of the bag which are formed by said sheet.

4. The method as claimed in one of claims 1 to 3, wherein the cutouts have a rectangular outline.

5. The method as claimed in one of claims 1 to 4, wherein the longitudinal spacing separating two adjacent pairs of cutouts is equal to the spacing of the bags.

6. The method as claimed in one of claims 1 to 5, wherein the transverse dimension of the cutout is equal to the combined width of the flaps defining a concave internal dihedron of the side gussets.

7. The method as claimed in one of claims 1 to 6, wherein the cutouts are symmetric with respect to the middle of the sheet.

8. The method as claimed in one of claims 1 to 7, wherein the distance separating the two cutouts is equal to the width of a main panel of which the bag is made.

9. The method as claimed in one of claims 1 to 8, wherein the side gussets are roughed out in the form of two longitudinal folds before the closure means are deposited.

10. The method as claimed in one of claims 1 to 9, wherein a support flange of the closure means, adjacent to the sheet, is fixed to the latter before the longitudinal edges of the sheet are brought together and fixed.

11. The method as claimed in claim 10, wherein the second support flange of the closure means is fixed to the sheet after the longitudinal edges of the sheet have been brought together.

12. The method as claimed in one of claims 1 to 11, wherein the closure means are fixed in such a way that this fixing seals the closure means to the sheet.

13. The method as claimed in one of claims 1 to 12, and which further comprises the step consisting in packing the tubular entity obtained after the aforementioned steps have been carried out, by rolling or by concertina-folding about transverse folds, with a view to later use.

14. The method as claimed in one of claims 1 to 12, and which further comprises the step consisting in making each bag into an individual bag by cutting transversely with a view to later filling and closing.

15. The method as claimed in one of claims 1 to 12, and which further comprises the step consisting in placing contents on the sheet before the longitudinal edges of the sheet are brought together and fixed, and which further comprises a step consisting in sealing each bag around these contents.

16. The method as claimed in one of claims 1 to 12, and which further comprises the step consisting in sequentially making transverse cutouts in the tubular entity obtained after the aforementioned steps have been performed, so as to form a string of bags in series, each comprising a cutout allowing subsequent filling of the bags.

17. A machine for manufacturing packaging bags with side gussets, comprising:
means capable of driving a sheet that is intended to form a packaging bag in a longitudinal direction which coincides with its direction of elongation,
means capable of sequentially forming pairs of cutouts in two respective regions of the sheet of packaging bag which regions are intended to form longitudinal side gussets,
means capable of sequentially and transversely placing closure means based on complementary profiles on the sheet facing the region thereof that lies between two associated cutouts,
means capable of forming longitudinal side gussets on the sheet,
means capable of bringing the longitudinal edges of the sheet together, fixing together these touching longitudinal edges of the sheet to close the bag, and fixing the closure means based on complementary profiles, onto the sheet,
wherein the means capable of forming pairs of cutouts are designed to make cutouts which open onto a transverse generatrix of the sheet corresponding to the top of a respective bag.

18. The machine as claimed in claim 17, wherein the closure means based on complementary profiles comprise an operating slider.

19. The machine as claimed in claim 17 or 18, wherein the closure means based on complementary profiles are borne by a strip folded onto itself in the shape of a U to form two support flanges which are roughly parallel to one another, oriented transversely to the longitudinal direction of the bag and fixed respectively to the inside of two main panels of the bag which are formed by said sheet.

20. The machine as claimed in one of claims 17 to 19, wherein the two support flanges of the closure means have different widths.

21. The machine as claimed in one of claims 17 to 20, wherein the means capable of forming the side gussets are formed of longitudinal blades which are offset in the transverse direction.

22. The machine as claimed in one of claims 17 to 21, wherein the sum of the width of panels formed on the outside of the cutouts is equal to the width of the panel formed between the cutouts plus twice the width needed to fix the longitudinal edges together.

23. The machine as claimed in one of claims 17 to 22, wherein the width of each elementary panel formed between a longitudinal edge and an internal fold is equal to the sum of half the width of a lower panel formed between two external folds, the depth of the gussets and the width needed to fix the longitudinal edges together.

24. The machine as claimed in one of claims 17 to 23, wherein the sum of the width of the two elementary panels formed respectively between the longitudinal edges and an external fold is equal to the sum of the width of the lower panel formed between the two external folds, twice the depth of the gussets and twice the width needed to fix the longitudinal edges together.

25. A packaging bag with side gussets obtained by implementing the method as claimed in one of claims 1 to 16 and/or by using the machine as claimed in one of claims 17 to 24.

26. The bag as claimed in claim 25, and which comprises closure means based on complementary profiles borne by a strip folded onto itself in the shape of a U to form two support flanges which are roughly parallel to one another, fixed respectively to the inside of two main panels of the bag which are formed by said sheet, between two cutouts made at the side gussets and which open onto a transverse generatrix of the sheet which corresponds to the top of a respective bag.

27. The bag as claimed in one of claims 25 and 26, wherein the closure means comprise a slider.

28. The bag as claimed in one of claims 25 to 27, wherein the U-shaped strip has its concave side facing toward the outside of the bag.

29. The bag as claimed in one of claims 25 to 28, wherein the strip is in the shape of a W, the closure profiles are placed between the insides of the U-shaped internal element of this strip, this U-shaped internal element having its concave side facing toward the outside and the lateral branches of the strip being fixed to the walls of the bag.
